(19) United States
(12) Patent Application Publication
(10) Pub. No.: US 2009/0193966 A1
(43) Pub. Date: Aug. 6, 2009

(54) Compressor Piston

(75) Inventors: Herman K. Phlegm, Oak Park, MI (US); Steven M. Haar, White Lake, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 12/026,599

(22) Filed: Feb. 6, 2008

(51) Int. Cl. F16J 1/01

(52) U.S. Cl. 92/248

(57) ABSTRACT

An injection molded piston formed integrally of polymer material includes a body extending along an axis and providing a mounting surface, first and second partial cylindrical surfaces located above the mounting surface and formed with a concave recesses, a first shoe located above the mounting surface and radially outboard of the cylindrical surfaces, and a second shoe located above the mounting surface and radially outboard of the cylindrical surfaces.

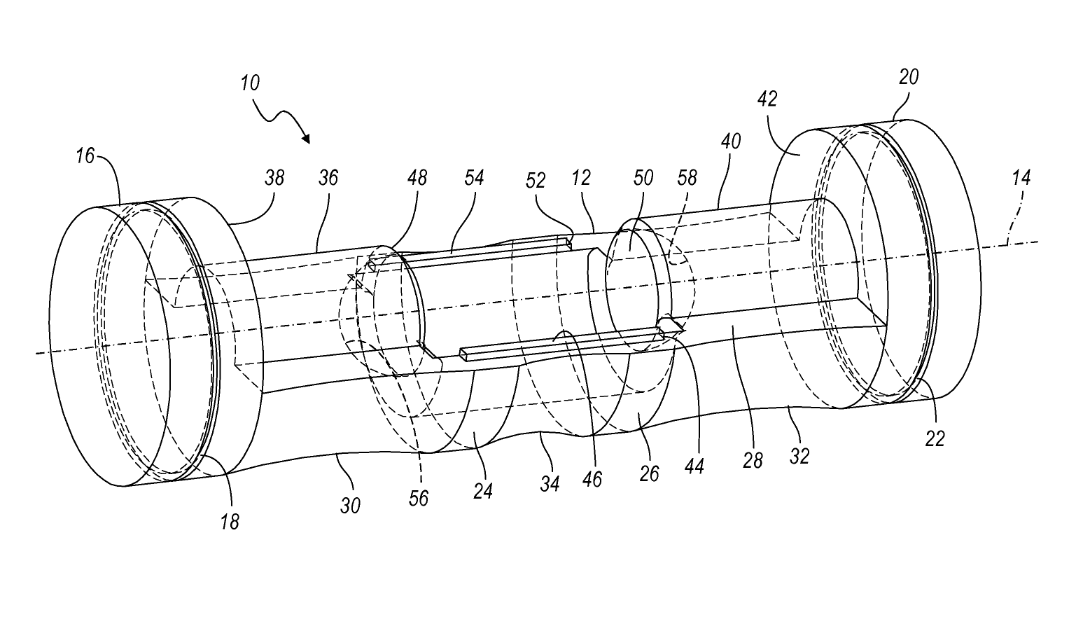

### BACKGROUND OF INVENTION

The present invention relates generally to a piston for a compressor of an air conditioning system of the type used in a motor vehicle, and, more particularly, to such a piston formed of synthetic polymer material.

It is conventional to form a piston for an air conditioning compressor from an aluminum alloy casting that is machined and coated with a material having an exceptionally low coefficient of friction, such as polytetrafluoroethylene (PTFE), a synthetic fluoropolymer available commercially from E. I. du Pont de Nemours and Company under the trademark Teflon™.

Injection molding is a technique for manufacturing a product from metal, thermoplastic and thermosetting plastic materials. Molten plastic is injected at high pressure into a mold, whose shape is the inverse of the product being formed.

Plastic resin, the raw material for injection molding, is usually provided in pellet or granular form, and is melted by heat and shearing forces shortly before being injected into the mold. Resin pellets are poured into a feed hopper, a large open bottomed container, which feeds the granules along a housing containing a long, rotating screw. The screw feeds the pellets along the housing length to the mold. The depth of flights formed on the screw decreases towards the end of the screw nearest the mold, thereby compressing the heated plastic. As the screw rotates, the pellets move forward undergoing extreme pressure and friction, which generates most of the heat needed to melt the pellets. Heaters external to the mold assist in heating the resin and control of its temperature during the melting process.

Injection molding machines, also known as presses, hold the mold in which the product is shaped. Pressure keeps the mold closed during the injection process. The mold is closed shut, and heated plastic is forced by the pressure of an injection screw to take the shape of the mold. Water-cooling channels may be used to assist in cooling the mold, and the heated plastic solidifies into the shape of the product. The injection molding process is completed when the mold opens and the part is ejected.

### SUMMARY OF INVENTION

An embodiment contemplates an injection molded piston formed integrally of polymer material that includes a body extending along an axis and providing a mounting surface, first and second partial cylindrical surfaces located above the mounting surface and formed with a concave recess, a first shoe located above the mounting surface and radially outboard of the cylindrical surfaces, and a second shoe located above the mounting surface and radially outboard of the cylindrical surfaces.

An advantage of an embodiment is a compressor piston whose weight is approximately one-half the weight of a conventional piston of machined aluminum alloy.

Injection molding the piston simplifies the forming process and reduces the manufacturing cost of the piston to substantially less than the cost of a conventional piston by eliminating the steps of machining aluminum alloy casting and coating its outer surfaces with Teflon. The forming process effectively produces a one-piece injection molded piston, whose outer surfaces have a coefficient of friction that approximates the conventional Teflon coating without requiring a secondary process of applying Teflon to certain outer surfaces where contact with a mating part occurs.

The piston increases the service life of the compressor by decreasing the work performed by the compressor's swash plate to reciprocate the piston.

### BRIEF DESCRIPTION OF DRAWINGS

The FIGURE is a perspective view of a refrigeration compressor piston.

### DETAILED DESCRIPTION

A compressor piston 10 includes a body 12 that extends along an axis 14 between a first piston wall 16, formed with an annular groove 18, and a second piston wall 20 formed with an annular groove 22.

Located on the body 12 between the piston walls 16, 18 are circular partial cylindrical lands 24, 26, which extend angularly about axis 14 to a planar mounting surface 28, which extends across the width of the body. Located on the outer surface of the body 12, between piston wall 16 and land 24, is a recess 30, whose contour is depressed below the periphery of lands 24, 26 and the periphery of the piston walls 16, 20. Similarly, located on the outer surface of the body 12, between piston wall 20 and land 22, is a recess 32, whose contour is depressed below the periphery of lands 24, 26 and the periphery of the piston walls 16, 20. A similar recess 34 is located between lands 24, 26. In this way, the radially outermost surfaces of piston 10 provide contact surfaces at the piston walls 16, 20 and lands 24, 26.

A first partial circular, cylindrical surface 36 located above the elevation of mounting surface 28 extends axially from the inner face 38 of piston wall 16. A second partial circular, cylindrical surface 40 located above the elevation of mounting surface 28 extends axially from the inner face 42 of piston wall 20. Cylindrical surfaces 36, 40 are aligned with axis 14 and concentric with piston walls 16, 18.

A first shoe 44 provides a contact surface 46, which is located above the elevation of mounting surface 28 and extends axially along the space between the ends 48, 50 of the cylinders 36, 40. A second shoe 52 provides a contact surface 46, which is located above the elevation of mounting surface 28 and extends axially parallel to shoe 44 and along the space between the end faces 48, 50. Shoes 44, 52 are arranged radially outboard of cylindrical surfaces 36, 40.

The axial end 48 of cylinder 32 is formed with a concave hemispherical recess 56 facing cylinder 40. The axial end 50 of cylinder 40 is formed with a concave hemispherical recess 58 facing cylinder 32.

In operation a swash plate (not shown) engages a swash-plate shoe, which in turn engages recesses 56, 58 and is partially supported on shoes 44, 52 at their contact surfaces 46, 54.

The piston 10 is a unitary, integrated component having no parts that are connected mechanically, bonded to or joined in any way to the piston. Piston 10 is preferably injection molded from an engineered polymer, such as polyetheretherketone (PEEK) reinforced with about 30 percent by volume of carbon fibers uniformly dispersed in short lengths throughout the PEEK matrix. The composite material comprising carbon fiber reinforced PEEK has a coefficient of friction of about 0.25, whereas the coefficient of fiction of Teflon is about 0.20.

Alternatively, piston 10 may be formed of a synthetic composite matrix comprising polyetherketone and about 15 percent by weight of polytetrafluoroethylene (PTFE) reinforced with about 15 percent by weight of carbon fibers uniformly dispersed in short lengths throughout the matrix.

Or piston 10 may be formed of a polyphenylene sulfide (PPS), which will perform similarly to a piston formed of carbon fiber-reinforced PEEK.

While certain embodiments of the present invention have been described in detail, those familiar with the art to which this invention relates will recognize various alternative designs and embodiments for practicing the invention as defined by the following claims.

What is claimed is:

1. A refrigeration compressor piston formed of polymer material comprising:
first and second piston walls concentric with an axis and spaced mutually along the axis;
a body portion extending axially between the piston walls and providing a mounting surface;
a first partial cylindrical surface located above an elevation of the mounting surface and extending axially from an inner face of the first piston wall;
a second partial cylindrical surface located above the elevation of the mounting surface and extending axially from an inner face of the second piston wall;
a first shoe located above the elevation of the mounting surface and radially outboard of the cylindrical surfaces; and
a second shoe located above the elevation of the mounting surface and radially outboard of the cylindrical surfaces.

2. The piston of claim 1 wherein the first and second cylindrical surfaces are aligned with the axis and concentric with the piston walls.

3. The piston of claim 1 wherein the body portion is formed with lands axially spaced mutually by a first recess, each land being axially spaced from one of the piston walls by a recess.

4. The piston of claim 1 wherein the first and second shoes extend axially and are located radially outboard of the cylindrical surfaces.

5. The piston of claim 1 wherein:
an axial end of the first cylindrical surface is formed with a concave recess facing the second piston wall; and
an axial end of the second cylindrical surface is formed with a concave recess facing the first piston wall.

6. The piston of claim 1 wherein the piston is formed of polyetheretherketone (PEEK) reinforced with about 30 percent by volume of carbon fibers dispersed in a PEEK matrix.

7. The piston of claim 6 wherein the piston is formed integrally by injection molding.

8. The piston of claim 1 wherein the piston is formed of polyetherketone and about 15 percent by weight of polytetrafluoroethylene (PTFE) reinforced with about 15 percent by weight of carbon fibers dispersed in a PTFE matrix.

9. The piston of claim 8 wherein the piston is formed integrally by injection molding.

10. The piston of claim 1 wherein the piston is formed of polyphenylene sulfide.

11. The piston of claim 10 wherein the piston is formed integrally by injection molding.

12. A refrigeration compressor piston formed of polymer material comprising:
a body extending along an axis and providing a mounting surface;
a first partial cylindrical surface located above the mounting surface and formed with a first concave recess;
a second partial cylindrical surface located above the mounting surface and formed with a second concave recess;
a first shoe located above an elevation of the mounting surface and radially outboard of the cylindrical surfaces; and
a second shoe located above the elevation of the mounting surface and radially outboard of the cylindrical surfaces.

13. The piston of claim 12 wherein the body portion is formed with lands axially spaced mutually by a first recess.

14. The piston of claim 12 wherein the first and second shoes extend axially and are located radially outboard of the cylindrical surfaces.

15. The piston of claim 12 wherein the piston is formed integrally of polyetheretherketone (PEEK) reinforced with about 30 percent by volume of carbon fibers dispersed in a PEEK matrix.

16. The piston of claim 15 wherein the piston is formed by injection molding.

17. The piston of claim 12 wherein the piston is formed integrally of polyetherketone and about 15 percent by weight of polytetrafluoroethylene (PTFE) reinforced with about 15 percent by weight of carbon fibers dispersed in a PTFE matrix.

18. The piston of claim 17 wherein the piston is formed by injection molding.

19. The piston of claim 12 wherein the piston is formed of polyphenylene sulfide.

20. The piston of claim 19 wherein the piston is formed integrally by injection molding.
